(19) United States
(12) Patent Application Publication
(10) Pub. No.: US 2024/0276480 A1
(43) Pub. Date: Aug. 15, 2024

(54) Search Space Configuration for PDCCH Capacity and Power Optimization

(71) Applicant: Telefonaktiebolaget LM Ericsson (publ), Stockholm (SE)

(72) Inventors: Ali Nader, Malmö (SE); Andres Reial, Höllviken (SE); Sina Maleki, Malmö (SE); Evanny Obregon, Solna (SE); Seungtai Kim, Solna (SE)

(21) Appl. No.: 18/568,094

(22) PCT Filed: Dec. 21, 2021
(86) PCT No.: PCT/EP2021/086936

§ 371 Date: Dec. 7, 2023

Related U.S. Application Data
(60) Provisional application No. 63/197,752, filed on Jun. 7, 2021.

(51) Int. Cl. H04W 72/12

(52) U.S. Cl. CPC H04W 72/12

(57) ABSTRACT

A scheduling node assigns search space configurations to wireless devices to facilitate power-efficient operation of the wireless devices and the scheduling node. In an example method, a scheduling node configures (810) each of a plurality of wireless devices with two or more respective search space configurations for monitoring for scheduling messages, the two or more respective search space configurations for each wireless device differing with respect to at least one of sparsity in time of scheduling occasions, time offset of scheduling occasions, and duration of scheduling occasions. This configuring comprises assigning (815) search space configurations to the plurality of wireless devices such that a first subset of the assigned search space configurations have a first time offset and a second subset of the assigned search space configurations have a second time offset.

### TECHNICAL FIELD

This document is generally related to wireless communications networks and is more particularly related to techniques for configuring search space configurations for use by wireless devices in detecting scheduling messages.

### BACKGROUND

In wireless communication systems, power consumption is an important metric for both wireless devices, commonly referred to as user equipments (UEs), in specifications for the wireless communication systems standardized by members of the 3^{rd}-Generation Partnership Projection (3GPP), and components of the network (NW), such as the NW's base stations, referred to as eNBs in LTE networks and gNBs in the 5G NR network. In general, significant power is spent by a UE in RRC_CONNECTED mode in monitoring the Physical Downlink Control Channel (PDCCH) in NR for potential scheduling of Physical Downlink Shared Channel (PDSCH) or Physical Uplink Shared Channel (PUSCH) transmissions. The UE needs to decode all PDCCH occasions, i.e., all possible time-frequency locations/configurations defined by a search space. After decoding according to each blind decoding (BD) option, the UE can check whether the PDCCH occasion carries a message targeted to the UE, based on checking the Cyclic Redundancy Check (CRC) using the UE's cell radio network temporary identifier (C-RNTI). If so, the UE follows the information within the downlink control information (DCI) carried over the PDCCH.

Similarly, from the NW perspective, significant power is consumed in scheduling data for various UEs. A NW node such as an NR gNB may be serving many UEs at the same time, with data arriving for and being received from the UEs at any given instant. Thus, the gNB may be scheduling UEs nearly constantly.

At least with respect to optimization of power consumption, then, there currently exist certain challenge(s). From the NW scheduling point of view, frequent (e.g., every slot) monitoring of PDCCH occasions by the UEs is desirable, since this allows high user throughput and cell data throughput (UEs can be scheduled every slot). Frequent monitoring of PDCCH occasions by the UE also facilitates low latency (a UE can be scheduled any slot). From the UE and NW power consumption points of view, however, frequent PDCCH occasions imply a lot of energy consumed both for the NW (in case of actual transmission) and for the UE (reception attempts irrespective of actual transmission by the NW).

It is not straightforward for a gNB to know how to configure PDCCH search spaces and when to command the UEs to change their search space configurations. Hence, the most common approach in practice is to configure a very dense search space (e.g., with PDCCH monitoring in every slot) for the sake of latency reduction.

### SUMMARY

Certain aspects of the disclosure and their embodiments may provide solutions to these or other challenges. More particularly, techniques detailed below consider both latency and UE/NW power consumption with respect to search space configuration. Techniques that can reduce PDCCH monitoring occasions allow both the UE and NW to utilize the gaps in-between the occasions for various sleep states depending on gap length. Such techniques are possible through configuration of various search spaces and offsets by the NW. The UEs can semi-statically (via radio resource control (RRC) Reconfiguration) or dynamically (via DCI commands from the NW) switch between the different configurations.

The described techniques can thus be employed by a scheduling node to assign search space configurations to wireless devices to facilitate power-efficient operation of the wireless devices and the scheduling node. In an example method, a scheduling node configures each of a plurality of wireless devices with two or more respective search space configurations for monitoring for scheduling messages, the two or more respective search space configurations for each wireless device differing with respect to at least one of sparsity in time of scheduling occasions, time offset of scheduling occasions, and duration of scheduling occasions. This configuring comprises assigning search space configurations to the plurality of wireless devices such that a first subset of the assigned search space configurations have a first time offset and a second subset of the assigned search space configurations have a second time offset.

This and other example methods are described in detail below and illustrated in the accompanying figures. Corresponding apparatuses and systems are also described.

Certain embodiments of the solutions described herein may be used to enable power saving on both the UE side and the NW side, with minimized impact on service latency.

### BRIEF DESCRIPTION OF THE FIGURES

FIG. 1 illustrates an example of a dense search space/monitoring configuration.

FIG. 2 illustrates an example of a relatively sparse search space/monitoring configuration.

FIG. 3 and FIG. 4 illustrate search space configurations for two user equipments (UEs).

FIG. 5 illustrates search space configurations having different offsets.

FIG. 6 is a flowchart illustrating a process in which offsets are used (mode A) or not used (mode B).

FIG. 7 is a process flow diagram illustrating a method as might be carried out in a scheduling node.

FIG. 8 is a process flow diagram illustrating another method as might be carried out in a scheduling node.

FIG. 9 shows an example of a communication system in accordance with some embodiments.

FIG. 10 is a block diagram illustrating an example UE.

FIG. 11 is a block diagram illustrating an example network node.

FIG. 12 shows an example virtualization environment.

### DETAILED DESCRIPTION

Some of the embodiments contemplated herein will now be described more fully with reference to the accompanying drawings. Embodiments are provided by way of example to convey the scope of the subject matter to those skilled in the art.

The techniques described herein include methods for the NW to enable power saving both in the UE and the NW through configuration of various search spaces and ordering the UE to dynamically operate in one of the different search spaces while in RRC Connected state.

For each UE and service, the gNB (or other scheduling node) may consider desired latency, and PDCCH capacity. As long as PDCCH capacity and service latency is not an issue, the scheduling node configures a sparse configuration for the UEs on overlapping PDCCH monitoring occasions, thereby saving power both on the UE and NW side (allowing for micro-sleep in UE and NW). Once PDCCH capacity and/or service latency becomes affected, the gNB reconfigures the UEs to either denser and/or non-overlapping occasions as described below.

In some embodiments, then, a method in a NW node dynamically (re-)configures and activates UE search space configuration according to the following principles, for the sake of power consumption reduction (either in the UE or NW) and/or PDCCH capacity:
Where the said search space (re-)configuration/activation is among at least two search space configurations, including a first configuration with relatively sparse (longer periodicity, i.e., low rate) monitoring occasions used during the period in which no/little (little: below a threshold) data exchange occurs between the UE and NW, and a second (or more) search space configuration(s) with relatively dense monitoring occasions used when more (than no little) data exchange takes place between the UE and the NW or in case the NW needs more PDCCH capacity than what was available while the first configuration was active.
Where the first configuration may be mainly used for services that tolerate the latency introduced by the sparse search space configuration and the configuration change delay. E.g., some services (e.g., Voice-over-NR, or VoNR) may be exempt from the different configurations and only active with e.g., one dense configuration. Alternatively, the first configuration may be configured for a period within which the UE is not expected to receive a burst of data.
Where the “sparseness” of the configurations is up to the level that still fulfils the service latency requirements.
In addition to the preceding features, in some embodiments the NW may operate according to a method in which it configures multiple UEs with overlapping search space occasions. Then the NW reconfigure the UEs to a denser search space configuration when it identifies PDCCH capacity limitation.
In addition to the preceding features, in some embodiments the NW may instead operate according to a method in which it configures multiple UEs with non-overlapping search space occasions. Then the NW may reconfigure the UEs to a sparser search space configuration when it identifies PDCCH capacity limitation to free up slots for more non-overlapping search space occasions.
In various embodiments or instances, a PDCCH capacity limitation may be identified (e.g., checked against one or more thresholds) by one or several of the following metrics:
a. a number of UEs currently active in the NW,
b. a number of UEs currently active in the NW and with overlapping search space occasions (i.e., a number of UEs potentially served during same slot),
c. a number of UEs with specific coverage level currently active in the NW and with overlapping search space occasions (i.e., a number of UEs potentially served during same slot),
d. a PDCCH load, e.g., by checking the allocated resources on PDCCH against a threshold.

According to various embodiments, at least two search spaces are configured for each UE. A first one entails sparse PDCCH monitoring occasions, i.e., a periodicity longer than 1, while the other entails a denser search space configuration. The search space may be configured by the parameters listed below (3GPP Technical Specification (TS) 38.331), only relevant parameters are pointed out below:

```
------------------------------- begin 3GPP specification excerpts ----------------------
SearchSpace ::= SEQUENCE {
  . . .
  monitoringSlotPeriodicityAndOffset CHOICE {
    sl1 NULL,
    sl2 INTEGER (0..1),
    sl4 INTEGER (0..3),
    sl5 INTEGER (0..4),
    . . .
    sl640 INTEGER (0..639),
    sl1280 INTEGER (0..1279),
    sl2560 INTEGER (0..2559) } OPTIONAL, -- Cond Setup
  duration INTEGER (2..2559) OPTIONAL,
  monitoringSymbolsWithinSlot BIT STRING (SIZE (14)) OPTIONAL, -- Cond Setup
. . .
}
  --------------------------------- end 3GPP specification excepts -------------------------
```

In the excerpts above, monitoringSlotPeriodicityAndOffset defines the slots for PDCCH

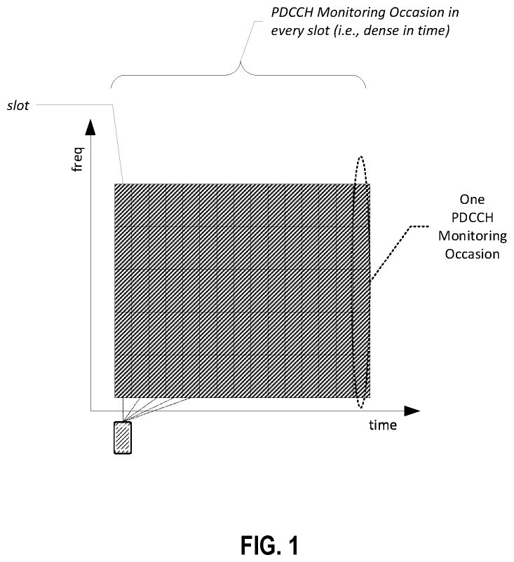

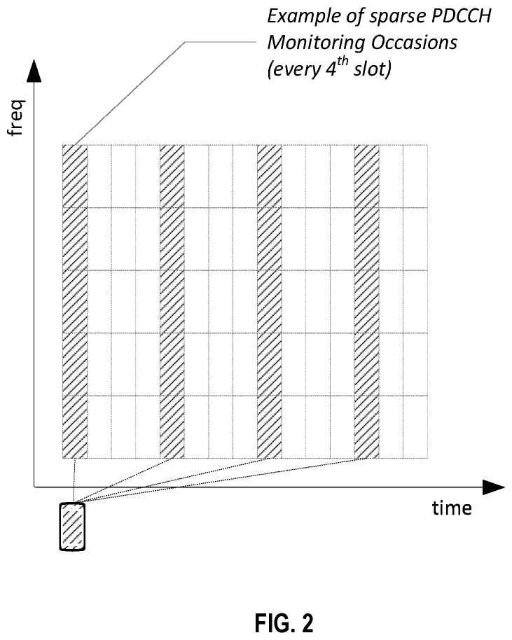

Monitoring configured as periodicity and offset. For example, sl1 means that the UE monitors the PDCCH in every slot (so-called dense configuration) as depicted in FIG. 1, whereas sl4 implies that the UE monitors the PDCCH in every 4th slot (so-called sparse configuration) as depicted in FIG. 2.

Other parameters that also control the PDCCH monitoring occasions (search space) are:
duration, which specifies the number of consecutive slots that a search space lasts in every occasion, i.e., upon every period as given in the monitoringSlotPeriodicityAndOffset.
monitoringSymbolsWithinSlot, where the bit(s) set to one identify the first OFDM symbol(s) of the control resource set within a slot.

Note that the terms “sparse” and “dense” as used herein are only relative between different search space configurations. For example, sl2 may seem sparse in front of an sl1 search space monitoring slot configuration, but is then seen as dense in comparison to, e.g., an sl5 search space monitoring slot occasion.

The term “search space occasion” or “monitoring occasion,” refers to a time interval in which a UE configured to monitor that search space occasion/monitoring occasion must be awake and must scan for the presence of a message directed to the UE. A single monitoring occasion may correspond to a single slot (and may require the UE to monitor for messages only during a few symbols of that slot) or may extend over several consecutive slots. Within any given monitoring occasion, there may be several or many combinations of time-frequency resources (resource elements, control channel elements etc.), aggregations of resources, and/or codings that the UE might be required to evaluate, for the presence of a message directed to the UE. The term “scheduling occasion,” as used herein, may be understood as synonymous with search space occasion or monitoring occasion.

The term “configuring,” as used herein with respect to an operation performed by a network node (e.g., an eNB, gNB, or other controlling node in a radio access network), refers to providing a target device, in particular a wireless device, with parameters and/or instructions that define certain aspects of the wireless device's operation. A particular focus of the present discussion is search space configuration, thus “configuring a search space” for a wireless device means providing the wireless device, either directly or by reference, with parameters that define what resources (in time and frequency) are to be employed by the wireless device when monitoring for scheduling messages. The parameters may be referred to as a “configuration,” e.g., a “search space configuration.”

When a wireless device has been provided with multiple configurations for the same thing, e.g., multiple search space configurations, a distinction may be made between “configuring” the wireless device with a configuration and “activating” a configuration. According to the techniques described herein, for example, a wireless device may be provided with multiple search space configurations. A scheduling node may then “activate” a search space configuration for the wireless device by sending an instruction to use a particular one of the previously configured search space configurations. Because “activating” a configuration may often involve the signaling of less information than “configuring” the configuration, it will be appreciated that the former may (but need not necessarily) use faster signaling methods, e.g., via downlink control information or MAC-layer signaling than the latter, which often uses Radio Resource Control (RRC)-layer signaling.

It should be noted that both the UE and the NW can enjoy various power saving states in case there is a distance between the monitoring occasions specified by a particular search space configuration. Different power saving states can be enjoyed depending on the gap in-between the monitoring occasions (e.g., between the radio-on occasions). For example, in the example depicted in FIG. 2, the UE can enjoy a so-called micro-sleep state (receiver off, e.g., RF section is OFF) in between the depicted monitoring occasions, while it cannot do that (or at least cannot do so very efficiently) in a fully dense search space configuration as the one depicted in FIG. 1, where the UE monitors the PDCCH monitoring occasion in every slot.

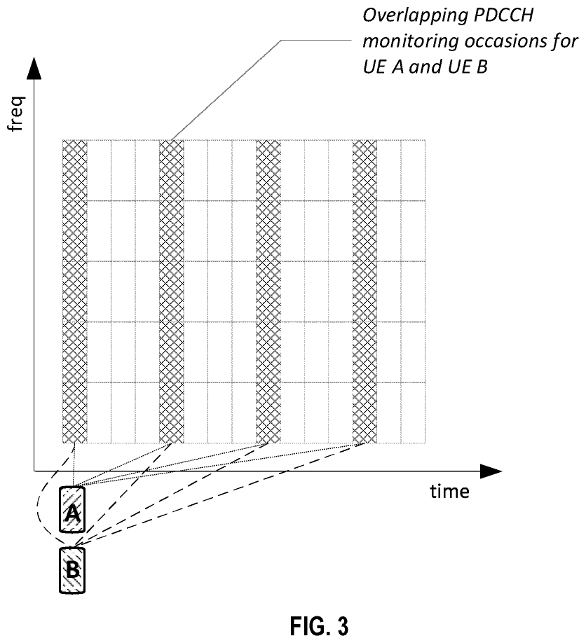

Note that similar logic holds for the NW side, in the event that no other activity is ongoing (e.g., no other UE is currently being served) in between the transmit/receive occasions. This can be seen in FIG. 3 and FIG. 4, where FIG. 3 depicts two UEs (UE A and UE B) with overlapping sparse search space configurations and FIG. 4 depicts two UEs (UE A and UE B) having non-overlapping sparse search space configurations, where the search space of UE B is offset by one slot compared to search space of UE B. Thus, for example, if only considering PDCCH transmissions and assuming that PDCCH transmission is ongoing (e.g., a constant flow of DL data), if all the UEs' search space occasions are overlapping as exemplified in FIG. 3, both the NW and the UEs may employ power saving states in between the occasions. In the case where offsets are used for the different UEs search spaces, as depicted in FIG. 4, the NW gets less chance of idle activity in between the PDCCH occasions, as more UEs are offset, while each individual UE still is enjoying the same power saving scheme as in FIG. 3.

A key aspect of various embodiments of the techniques described herein is that the NW may, when possible, configure search spaces that allow both the UE (and the NW) to have gaps in between configured monitoring occasions, for the sake of power saving. For the sake of latency impact alleviation, more than one search space may be configured, e.g., one dense (e.g., sl1, which is depicted in FIG. 1) used during the time when more than a threshold amount of data exchange is taking place between the NW and the UE (the threshold may be zero, or several kilobits per second), while a sparse search space configuration (e.g., sl4, which is depicted in either FIG. 3 or FIG. 4) is used when there is a relatively small (or no) data exchange ongoing between the NW and the UE. In all aspects, the NW considers the maximum acceptable latency for the expected/current services used by the UE when configuring the maximum sparseness of search space.

In some embodiments or instances, the NW may choose not to configure any sparse search space configuration for UEs that are involved in certain latency-sensitive services (e.g., only configure sl1 monitoring occasions for voice over NR (VONR) while doing so with other UEs involved in less-sensitive services such as web-browsing, chatting service, etc.

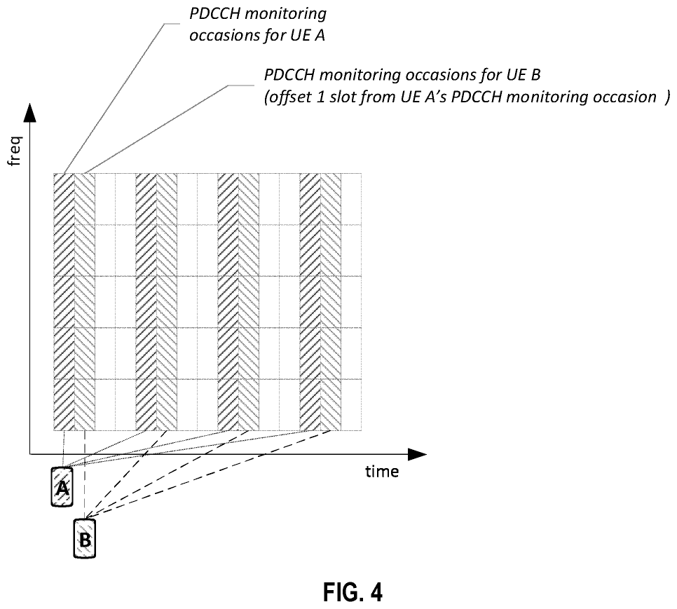

In addition to the power saving aspect, a NW node operating according to the techniques described herein may also take the PDCCH load and/or PDCCH blocking probability into account when configuring and activating/switching the UEs between the different search space configurations. The (re-)configuration/activation method used by the NW is dependent on the mode it is operating on with respect to configured search space offsets. Either the NW is configuring the UEs in connected mode without any offsets (i.e., overlapping search spaces as depicted in FIG. 3) or including offsets (i.e., non-overlapping search spaces) for one or several UEs. Note that the term “several UEs” refers to the scenario where some UEs may have the same offset while others use another offset. An example, which can be seen in FIG. 5, depicts six UEs with a NW search space configuration where offsets are used for a sub-set of UEs (UE E and UE F). As seen in that example, some UEs have overlapping occasions but not all UEs are overlapping in the exact same occasion. As such, in one example, if the PDCCH blocking probability is above a first threshold, the NW configures the UEs with overlapping sparse search spaces (SSs), and if the same probability goes above the first threshold, then the NW starts offsetting the UEs, and if the probability goes above a second threshold, then the NW may increase the duration of each search space (SS) to open up more resources for PDCCH, e.g., if the initial SS is configured with duration 1, then the NW configures the UE with duration 2 SSs. Note that offsetting or increasing the duration of SSs does not necessarily need to be applied to all SSs, i.e., it can only be applied to one or more of the SSs which experience PDCCH resource limitation. Furthermore, the second threshold is not necessarily larger than the first threshold or vice versa. For example, if NW power saving is a critical criterion, the NW may first decide to increase the SS duration to still have gaps between the SSs for micro-sleep, and thus the second threshold would be smaller than the first threshold, while if UE power saving is more critical, then the first threshold is smaller than the second threshold, such that the UE monitors less SSs. The same criteria can be used to any other metric representing the raise in PDCCH resource limitations, e.g., the number of UEs within the cell, or the number of UEs configured to monitor a specific SS.

The NW might have distributed to UEs based on expected traffic or current coverage. For example, the UEs A-D in FIG. 5 might be in good coverage and not heavy consumers of PDCCH in terms of aggregation level and thereby the NW node has used a first offset setting for them, whereas UEs E-F are in poor coverage and in need of higher aggregation levels used for PDCCH transmission (higher load on PDCCH) and the NW node has assigned a second offset setting to these UEs. In other words, the NW node may only allow a certain number of heavy PDCCH consumer (e.g., poor coverage) per offset. The NW may also change strategy during the course of time when it comes to offset usage. For example, the NW may initially not use offsets and configure overlapping search spaces for all UEs, to accommodate better sleep schemes for the NW side as well. However, as the PDCCH starts to become a bottleneck (e.g., the number of UEs admitted to connected mode grow above a threshold, too many UEs overlap in the same slot, or too many UEs of a certain coverage overlap with other UEs), the NW may start offsetting new UEs admitted to the system (or alternately reconfigure existing UEs search spaces with offsets).

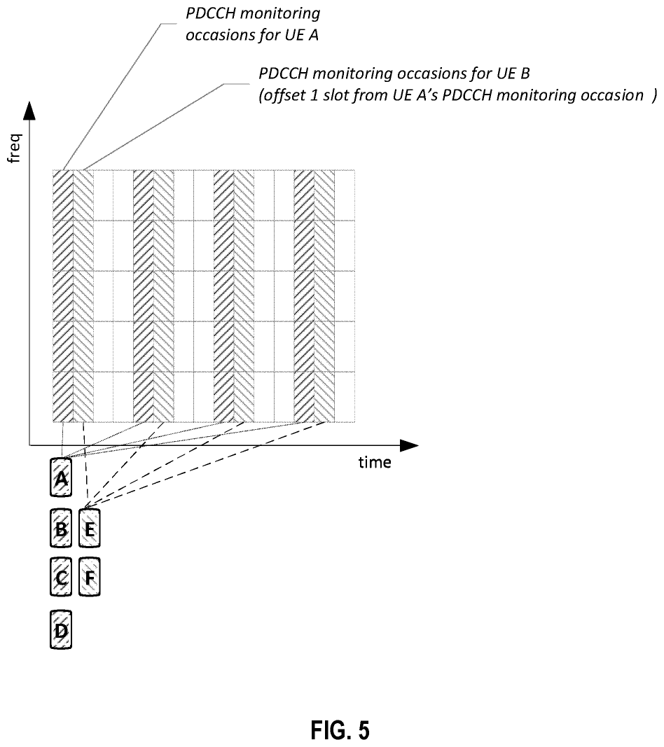

These different modes (offset-used/offset-not-used) lead to different behaviors when PDCCH capacity/load drives the search space configuration/activation change. The different actions are explained in the steps below and are also exemplified in the flowchart depicted in FIG. 6, which illustrates an example method comprising a mode where offset is used (Mode A) and a mode where offset is not used (Mode B).

A PDCCH load-triggered search space configuration/activation change can be based on the NW keeping track of any combination of:
Checking or determining the PDCCH current or average load (over a certain time window) against a Threshold (Thresh_{HighLoad} in the flowchart of FIG. 6),
Checking or determining number of UEs in connected mode above a certain threshold,
Checking or determining number of UEs with certain coverage above an associated threshold.

If UE-specific search space offsets are not used (Mode B in flowchart of FIG. 6), upon PDCCH load increase detection (step 200), the number of potential PDCCH instances for reaching the UEs are increased by search space densification (step 210), either by reconfiguring the search space (through any combination of the parameters monitoringSlotPeriodicityAndOffset, and/or duration, and/or monitoringSymbolsWithinSlot) if no such configuration exist in the UE or by commanding the UE to switch/activate the denser search space configuration if there already exist a preconfigured denser search space in the UE. In one aspect, the bandwidth (BW) used by the UE is also reconfigured to higher BW (e.g., through bandwidth part switch (BWP switch), or RRC reconfigured BW) in case densification alone is not enough to provide necessary PDCCH capacity.

If UE-specific search space offsets are used (Mode A in flowchart of FIG. 6), upon PDCCH load increase detection (step 100) in the slots, UEs are initially offset into other slots. If such offsetting still leads to a high PDCCH load, if the currently running UE services allow for increased latency (step 110, Yes), a sparser search space configuration/activation is ordered to the UE (step 130) thereby freeing up slots for more PDCCH activity. On the other hand, if the currently running UE services does not allow for increased latency (step 110, No), a densification of search space is done (step 120, which is similar as step 210 of Mode B). Such PDCCH densification allows for more potential PDCCH allocation even though not all occasions will be used by the NW to schedule the UE (i.e., resource potential increase at the cost of UE power consumption). In any of the cases, if the dense configuration allows for offset usage (i.e., anything else than sl1) UEs are offset between slots (step 140).

In another set of examples, a UE may be configured with a first sparse search space (SS), and a first dense SS where the first SS are configured based on coverage, e.g., UEs in good coverage (e.g., UEs experiencing SINR>10 dB) are configured with the same SS. Then if the UE coverage starts deteriorating, thereby in need of a larger aggregation level (AL), and thus larger PDCCH resources, the UE is configured with at least a second sparse SS where the second sparse SS is at least different from the first SS in one of the offset or duration.

In another set of examples, the UEs in a good coverage may be configured with a first sparse SS and a first dense SS, and the UEs in the worse coverage maybe configured with a second sparse SS and a second dense SS, where the second sparse SS has a lower periodicity than the first sparse SS, e.g., the first sparse SS has a periodicity of 8 slots (sl8), and the second sparse SS has a periodicity of 4 slots (sl4). The reason for that is that the UEs in good coverage need less PDCCH resources, and this a sparser SS is possible, but UEs in the worse coverage may need larger PDCCH resources and thus a faster periodicity can relieve the pressure on PDCCH resources.

In another set of examples, and following the logics in the previous examples, the NW can configure different UEs or different group of UEs to monitor different starting symbol in a slot for a SS to reduce the PDCCH blocking probability, or increase the PDCCH resources. E.g., the UE may be configured with a common resource set (Coreset) with frequency span of one symbol, and thus the NW can configure up to 14 different SSs in the same slot, or that the Coreset duration is 2 symbols, and thus the NW can have up to 7 different SSs, or that the Coreset duration is 3 symbols, and thus the NW can have up to 4 different SSs.

There is a different type of search space apart from UE-specific search space, common search space (CSS) which is dedicated for common control messages like system information block (SIB), random access and paging. These messages are broadcasted to all UEs in a cell including bad coverage users/UEs, e.g., at the cell edge. Therefore, high control channel elements (CCEs) are used to send PDCCH for these broadcast messages which are normally transmitted in specific slots. This means in those specific slots where the broadcasting messages are transmitted, PDCCH blocking probability is getting higher and in worst case there are not much PDCCH resources left for UE specific SS since broadcasting messages normally have higher scheduling priority.

Also, there are specific downlink (DL) slots where DCIs (on PDCCH) for unlink (UL) data transmission (UL grant) are transmitted. In those DL slots, it is quite common that not many DCIs (on PDCCH) can be transmitted for DL in order to allow UL data transmission in UL slots. This is mainly because UL data transmission can have a higher priority than DL since it is not known what type of UL data is in the UE buffer when UE sends Scheduling Request (SR). Also, UL slots are much fewer than DL slots in time division duplex (TDD) and hence it is important to schedule UL grant in those DL slots since otherwise there is a latency impact to wait until next UL slot.

To consider above aspects, for example, NW can exclude these CSS and UL related slots, where less PDCCH resources are available, when considering monitoringSlotPeriodicityAndOffset configuration for sparse search space, especially the ones with large period or for bad coverage. On the other hand, these slots can be used for sparse search space with low period or for good coverage since the latency impact and the required PDCCH resources would be small in these cases.

Another aspect to consider is PDCCH misdetection, which normally happens with a certain PDCCH transmission error rate, e.g., 1%. If PDCCH misdetection happens when changing from dense to sparse search space configuration, the UE will stay in the dense search space configuration. In this case the impact would be negligible except the power saving aspect, since UE can still receive PDCCH with dense search space configuration.

However, if PDCCH misdetection happens when changing from sparse to dense search space configuration, the impact could be quite big since UE will stay in the sparse search space configuration and hence cannot receive the PDCCH in most of the cases.

In order to solve this problem, the NW may schedule PDCCH with the sparse search space configuration with a new BWP identity (ID), which is configured with dense search space configuration, in case the first DL transmission after search space configuration switch is subject to discontinuous transmission (DTX). And if this second DL transmission with the sparse search space is not subject to DTX, i.e., ACKed or NACKed, the NW will schedule PDCCH with the dense search space configuration again.

The latency impact of sparse search space configuration could be quite severe in case Connected mode discontinuous reception (C-DRX) is used together with the sparse configuration with large period and/or for bad coverage. For example, there could be only one scheduling occasion available for the user configured with the very sparse search space configuration during the discontinuous reception (DRX) duration, e.g., 10 slots. If the UE misses this scheduling occasion for any reason, e.g., PDCCH blocking, it has to wait for a long DRX cycle duration, e.g., 160 ms, which has an impact on the latency.

In order to avoid such a problem, a scheduling weight factor Fss, which drives the scheduling priority, can be used for the user/UE with sparse search space configuration when C-DRX is enabled. The following formula is an example of scheduling weight factor Fss and the unit is in slot:

$$Fss = k * ( periodicity of sparse search space ) / ( length of DRX duration ) ,$$

where k=0 if periodicity of sparse search space=1, i.e., dense search space, otherwise, normalized compensation value to balance with other scheduling weight factors.

This formula aims to prioritize a UE with the sparse SS and give weight to it, where the specific weight is based on the NW implementation.

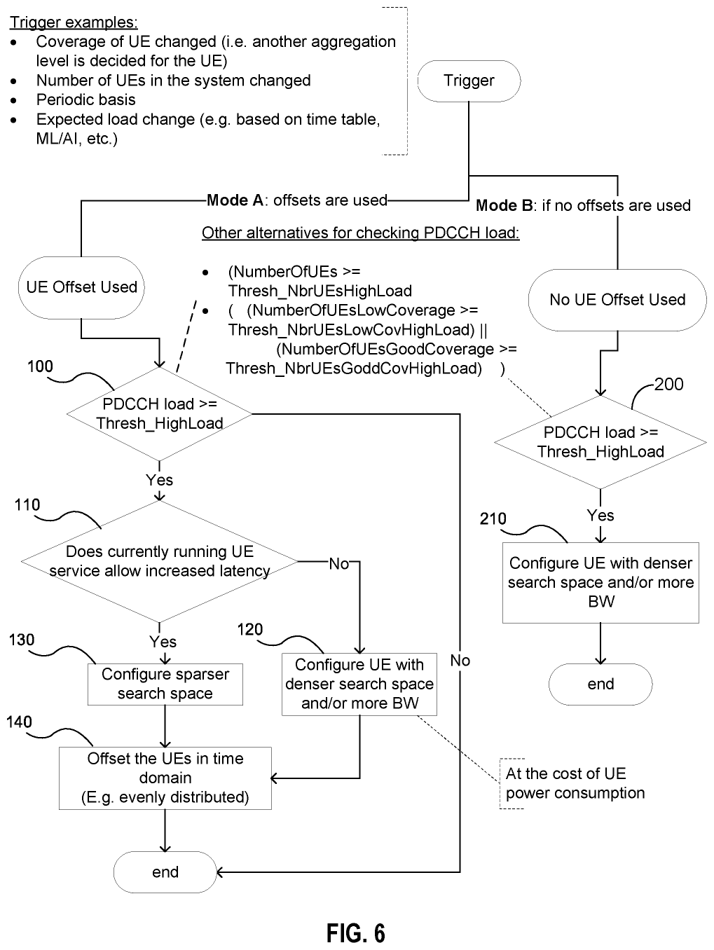

FIG. 7 is a process flow diagram illustrating another method, as might be carried out in a scheduling node, such as a gNB or eNB. This method and its variations may overlap and/or complement the method shown in FIG. 6. Thus, many of the variations and details discussed for the method shown in FIG. 6 are applicable to the method shown in FIG. 7, as well. Note that where minor differences in terminology are used, it should be generally assumed that the terms refer to the same thing, except where the context clearly indicates otherwise.

As shown at block 720, the method comprises configuring a first subset of wireless devices served by the scheduling node to use a first one of two or more search space configurations for monitoring for scheduling messages. As shown at block 730, the method further comprises configuring a second subset of wireless devices served by the scheduling node to use a second one of the two or more search space configurations, the first and second ones of the two or more search space configurations differing from each other with respect to any one or more of (a) sparsity in time of scheduling occasions, (b) time offset of scheduling occasions, and (c) duration of scheduling occasions. In carrying out the configurations shown in blocks 720 and 730, the scheduling node assigns wireless devices to the first or second subset based on latency requirements and/or throughput requirements for the wireless devices.

The method may further comprise the step of scheduling one or more wireless devices in either or both of the first and second subsets for reception and/or transmission of data, using scheduling messages sent according to the search space configurations configured for the respective wireless devices. This is shown at block 740.

In some embodiments, this scheduling step may comprise, for each of one or more wireless devices, determining a search space factor, based on sparsity of the search space configuration configured for the wireless device and a discontinuous receive (DRX) duration configured for the wireless device. The scheduling step may further comprise, for a given scheduling occasion, prioritizing the wireless devices for scheduling according to the search space factors. These sub-steps are shown at blocks 742 and 744 in FIG. 7.

In some embodiments or instances, for example, the scheduling weight factor Fss. which might also be referred to as a search space factor, is calculated according to k*periodicity/DRX-duration, where k=0 for a wireless device configured to monitor for scheduling messages in every scheduling opportunity and k>0 otherwise, periodicity is a periodicity of scheduling opportunities for the wireless device, and DRX-duration is a DRX duration configured for the wireless device.

In various embodiments, the method may further comprise selecting at least one of the two or more search space configurations from three or more available search space configurations, based on one or more of any of: a maximum acceptable latency for each of one or more services provided to wireless devices served by the scheduling node; a minimum throughput requirement for each of one or more services provided to wireless devices served by the scheduling node; an expected loading of one or more scheduling occasions, in view of the selected search space configurations; and power savings needs for one or more wireless devices. This is shown at block 710 of FIG. 7.

In some of these embodiments, and/or in some instances, selecting at least one of the two or more search space configurations may comprise determining that an expected loading of one or more scheduling occasions is greater than a predetermined threshold, for a given selected search space configurations, and selecting a search space configuration that has no overlap with another selected search space configuration, in response to said determining. Similarly, in some embodiments or instances, said selecting takes into account opportunities for a power saving state for the network node between scheduling occasions and/or takes into account opportunities for a power saving state for wireless devices between scheduling occasions.

In some embodiments, and/or in some instances, the method may comprise changing a selection of two or more search space configurations from three or more available search space configurations, based on one or more of any of: a change in loading for one or more scheduling occasions; and a change in a number of UEs served by the network node. This may comprise, for example, changing from a selection of two search space configurations having overlapping scheduling opportunities to a selection of two search space configurations having non-overlapping scheduling opportunities. Likewise, this may comprise replacing a selected search space configuration with a search space configuration having a longer duration, and/or replacing a selected search space configuration with a search space configuration having denser scheduling opportunities. Similarly, changing a selection may comprise replacing at least one selected search space configuration with a search space configuration having a higher bandwidth.

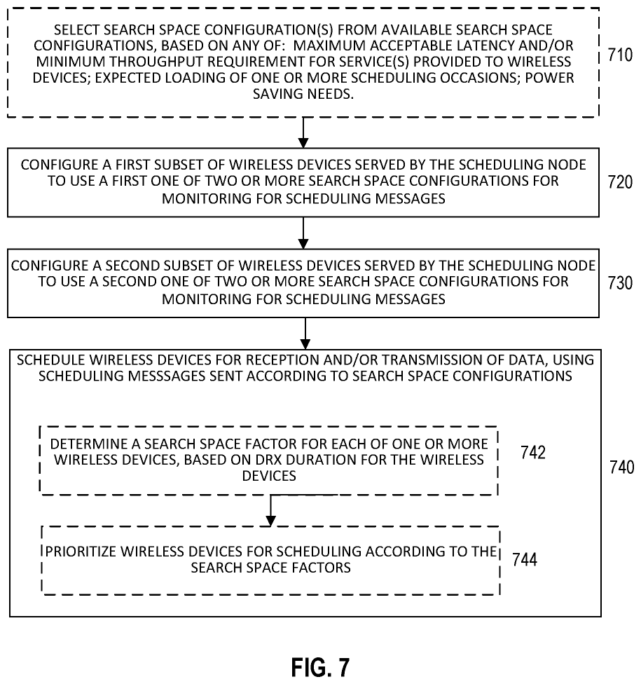

FIG. 8 is a process flow diagram illustrating another example method, as carried out by a scheduling node of a wireless communication system, such as an eNB or gNB. This method overlaps considerably with the method shown in FIG. 7 and, like the method shown in FIG. 7, facilitates power-saving operation of both the scheduling node and the wireless devices. As shown at block 810, the method comprises configuring each of a plurality of wireless devices with two or more respective search space configurations for monitoring for scheduling messages. The two or more respective search space configurations for each wireless device differ with respect to at least one of (a) sparsity in time of scheduling occasions, (b) time offset of scheduling occasions, and (c) duration of scheduling occasions. As shown at block 815, this configuring of the plurality of wireless devices comprises assigning search space configurations to the plurality of wireless devices such that a first subset of the assigned search space configurations have a first time offset and a second subset of the assigned search space configurations have a second time offset.

In some embodiments or instances, this configuring may comprise, for at least one wireless device, configuring a first search space configuration having a first sparsity and a second search space configuration having a second sparsity, where the first and second search space configurations correspond to first and second bandwidth part (BWP) IDs configured for the at least one wireless device.

In some embodiments or instances, the method further comprises, for each of one or more of the wireless devices, activating one of the configured two or more search space configurations for the respective wireless device, based on a latency requirement and/or a throughput requirement for the respective wireless device. This is shown at block 820, which is illustrated with a dashed outline to indicate that it need not occur in every instance of the method.

In some embodiments or instances, the method may further comprise, for each of a first group of the wireless devices, activating a respective configured search space configuration having a first time offset of scheduling occasions and, responsive to a load in the scheduling node exceeding a predetermined threshold, activating a respective configured search space configuration having a second time offset of scheduling occasions for each of a second group of wireless devices. This is shown at block 830, which again is illustrated with a dashed outline to indicate that it need not occur in every instance of the method. The load referred to here may be a control channel load, e.g., the PDCCH load. The load under consideration may be the load for a specific scheduling occasion, in some embodiments or instances. The first time offset and second time offset referred to here may correspond to adjacent slots, in some embodiments or instances, so as to maximize a gap between scheduling occasions.

In some embodiments or instances of the method shown in FIG. 8, the search space configurations assigned to the plurality of wireless devices may include configurations having a first sparsity in time of scheduling occasions and configurations having a second sparsity in time of scheduling occasions, the first sparsity being less than the second sparsity. In some of these embodiments or instances, at least some of the configurations having the first sparsity in time may have scheduling occasions that coincide with scheduling occasions of at least some of the configurations having the second sparsity in time.

In some embodiments or instances of the method shown in FIG. 8, the method may further comprise, for each of one or more wireless devices, determining a search space factor, based on sparsity of a search space configuration configured for the respective wireless device and based on a discontinuous receive (DRX) duration configured for the respective wireless device, and, for a given scheduling occasion, prioritizing the wireless devices for scheduling according to the search space factors. This is shown in FIG. 8 as blocks 840 and 845. The search space factor Fss may be calculated according to k*periodicity/DRX-duration, where k=0 for a wireless device configured to monitor for scheduling messages in every scheduling opportunity and k>0 otherwise, periodicity is a periodicity of scheduling opportunities for the wireless device, and DRX-duration is a DRX duration configured for the wireless device.

In some embodiments or instances of the method shown in FIG. 8, the method may comprise selecting at least one search space configuration to be assigned to the wireless device from available search space configurations, based on one or more of any of: a maximum acceptable latency for each of one or more services provided to the wireless devices; a minimum throughput requirement for each of one or more services provided to the wireless device; an expected loading of one or more scheduling occasions, in view of the selected search space configurations; power savings needs for the wireless device. This may be viewed as part of the configuring shown at block 810, and is not illustrated separately in FIG. 8. This selecting may comprise determining that an expected loading of one or more scheduling occasions is greater than a predetermined threshold, for search space configurations having a first time offset of scheduling configurations, and selecting a search space configuration that has no overlap with another selected search space configuration, in response to said determining. In some embodiments or instances, this selecting takes into account opportunities for a power saving state for the network node between scheduling occasions. In some of these embodiments or instances and in some others, this selecting (also) takes into account opportunities for a power saving state for wireless devices between scheduling occasions.

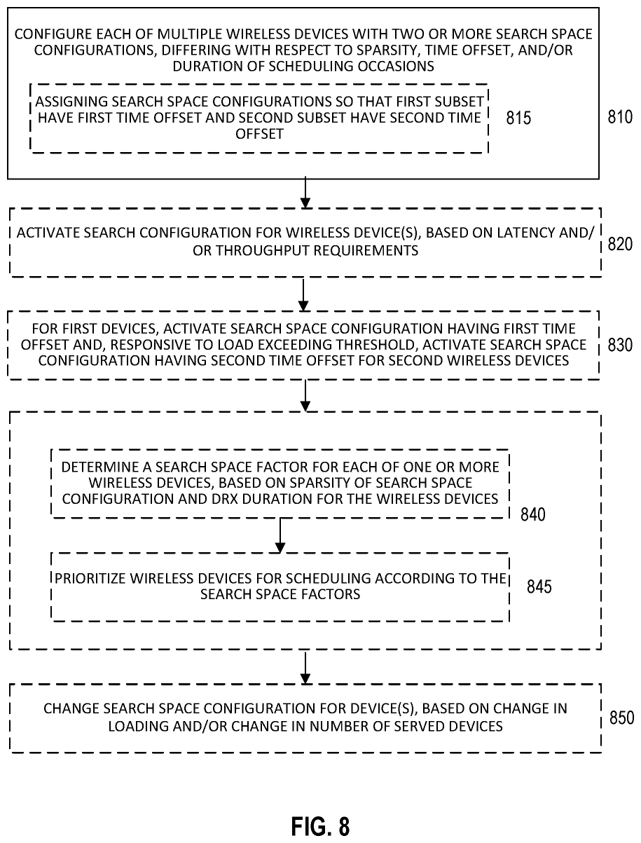

In some embodiments or instances of the method shown in FIG. 8, the method comprises changing a search space configuration for one or more wireless devices, based on one or more of any of: a change in loading for one or more scheduling occasions; and a change in a number of UEs served by the network node. This is shown at block 850. FIG. 9 shows an example of a communication system 900 in accordance with some embodiments.

In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3^{rd} Generation Partnership Project (3GPP) access node or non-3GPP access point. The network nodes 910 facilitate direct or indirect connection of user equipment (UE), such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

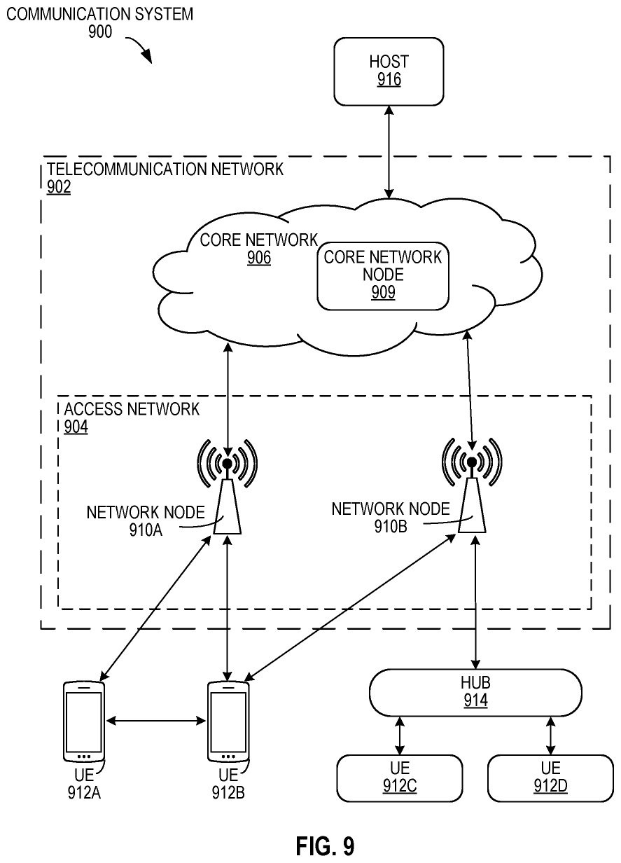

FIG. 10 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

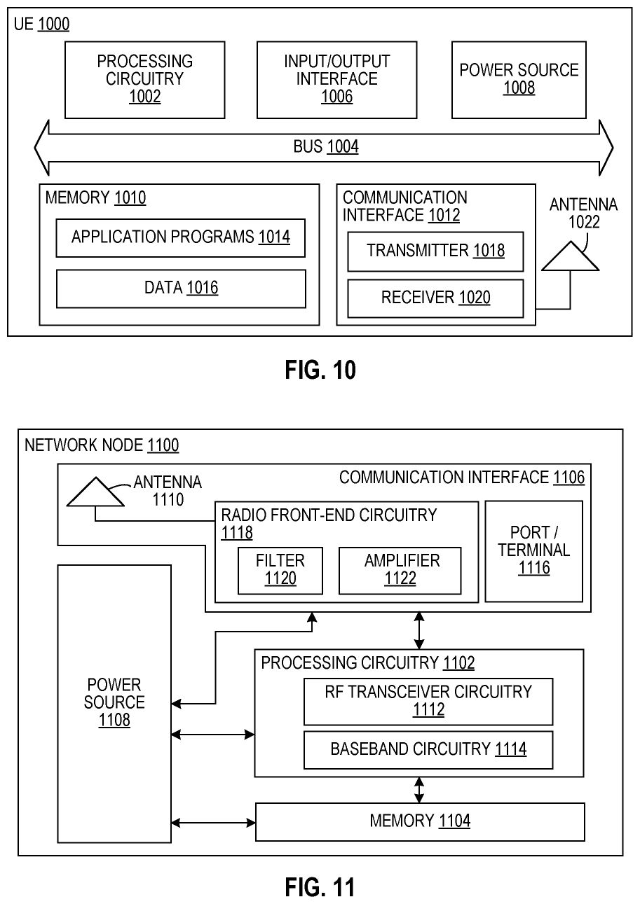

FIG. 11 shows a network node 1100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

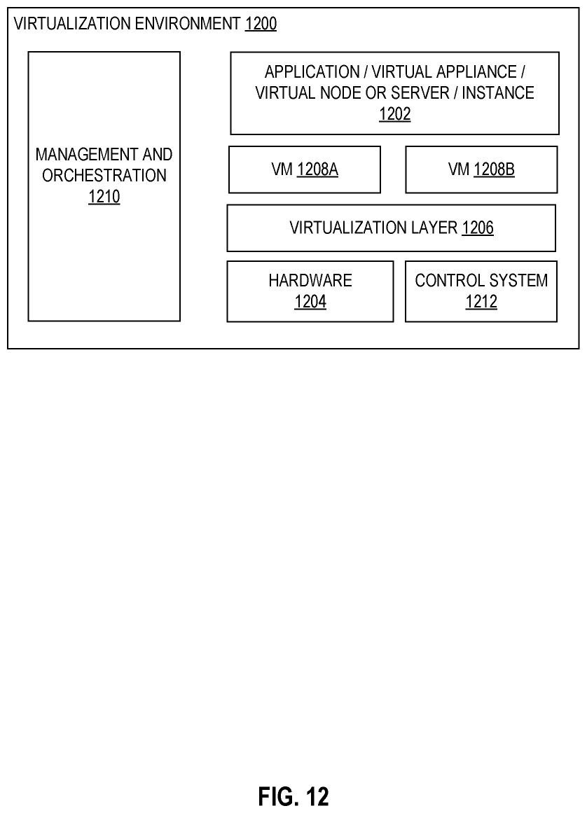

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

Although the computing devices described herein (e.g., UEs, network nodes) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Further Embodiments

Further embodiments of the techniques, apparatuses, and systems described herein include, but are not limited to, the following enumerated examples:

1. A method, in a scheduling node of a wireless communication system, the method comprising:
configuring a first subset of wireless devices served by the scheduling node to use a first one of two or more search space configurations for monitoring for scheduling messages; and
configuring a second subset of wireless devices served by the scheduling node to use a second one of the two or more search space configurations, the first and second ones of the two or more search space configurations differing from each other with respect to any one or more of (a) sparsity in time of scheduling occasions, (b) time offset of scheduling occasions, and (c) duration of scheduling occasions;
   wherein the method comprises assigning wireless devices to the first or second subset based on latency requirements and/or throughput requirements for the wireless devices.

2. The method of example embodiment 1, further comprising:
scheduling one or more wireless devices in either or both of the first and second subsets for reception and/or transmission of data, using scheduling messages sent according to the search space configurations configured for the respective wireless devices.

3. The method of example embodiment 1 or 2, further comprising:
for each of one or more wireless devices, determining a search space factor, based on sparsity of the search space configuration configured for the wireless device and a discontinuous receive (DRX) duration configured for the wireless device; and
for a given scheduling occasion, prioritizing the wireless devices for scheduling according to the search space factors.

4. The method of example embodiment 3, wherein the search space factor Fss is calculated according to k*periodicity/DRX-duration, where k=0 for a wireless device configured to monitor for scheduling messages in every scheduling opportunity and k>0 otherwise, periodicity is a periodicity of scheduling opportunities for the wireless device, and DRX-duration is a DRX duration configured for the wireless device.

5. The method of any one of example embodiments 1-4, wherein the method comprises: selecting at least one of the two or more search space configurations from three or more available search space configurations, based on one or more of any of:
a maximum acceptable latency for each of one or more services provided to wireless devices served by the scheduling node;
a minimum throughput requirement for each of one or more services provided to wireless devices served by the scheduling node;
an expected loading of one or more scheduling occasions, in view of the selected search space configurations;
power savings needs for one or more wireless devices.

6. The method of example embodiment 5, wherein said selecting at least one of the two or more search space configurations comprises:
determining that an expected loading of one or more scheduling occasions is greater than a predetermined threshold, for a given selected search space configurations; and
selecting a search space configuration that has no overlap with another selected search space configuration, in response to said determining.

7. The method of example embodiment 5 or 6, wherein said selecting takes into account opportunities for a power saving state for the network node between scheduling occasions.

8. The method of any one of example embodiments 5-7, wherein said selecting takes into account opportunities for a power saving state for wireless devices between scheduling occasions.

9. The method of any one of example embodiments 1-8, wherein the method comprises changing a selection of two or more search space configurations from three or more available search space configurations, based on one or more of any of:
a change in loading for one or more scheduling occasions; and
a change in a number of UEs served by the network node.

10. The method of example embodiment 9, wherein said changing a selection comprises changing from a selection of two search space configurations having overlapping scheduling opportunities to a selection of two search space configurations having non-overlapping scheduling opportunities.

11. The method of example embodiment 9, wherein said changing a selection comprises replacing a selected search space configuration with a search space configuration having a longer duration.

12. The method of example embodiment 9, wherein said changing a selection comprises replacing a selected search space configuration with a search space configuration having denser scheduling opportunities.

13. The method of example embodiment 9, wherein said changing a selection comprises replacing at least one selected search space configuration with a search space configuration having a higher bandwidth.

15. A network node, the network node comprising:
processing circuitry configured to perform any of the steps of any of the example embodiments 1-13; and
power supply circuitry configured to supply power to the processing circuitry.

1-33. (canceled)

34. A method, in a scheduling node of a wireless communication system, the method comprising:
configuring each of a plurality of wireless devices with two or more respective search space configurations for monitoring for scheduling messages, the two or more respective search space configurations for each wireless device differing with respect to at least one of (a) sparsity in time of scheduling occasions, (b) time offset of scheduling occasions, and (c) duration of scheduling occasions; and
for each of one or more of the wireless devices, activating one of the configured two or more search space configurations for the respective wireless device, based on a latency requirement and/or a throughput requirement for the respective wireless device.

35. The method of claim 34, wherein activating one of the configured two or more search space configurations for the respective wireless device comprises:
activating a first search space configuration, which has a first sparsity in time of scheduling occasions, when a data exchange from or to the wireless device is higher than a threshold or a higher control channel capacity is needed than what is available when a second search space configuration is active; and
activating a second search space configuration, which has a second sparsity in time of scheduling occasions, when a data exchange from or to the wireless device is less than the threshold;
wherein the first sparsity is less than the second sparsity.

36. The method of claim 34, wherein the method comprises, for each of a first group of the wireless devices, activating a respective configured search space configuration having a first time offset of scheduling occasions and, responsive to a load in the scheduling node exceeding a predetermined threshold, activating a respective configured search space configuration having a second time offset of scheduling occasions for each of a second group of wireless devices.

37. The method of claim 36, wherein the load is a control channel load or a load for a specific scheduling occasion.

38. The method of claim 36, wherein the first time offset and second time offset correspond to adjacent slots, so as to maximize a gap between scheduling occasions.

39. The method of claim 34, wherein the search space configurations assigned to the plurality of wireless devices include configurations having a first sparsity in time of scheduling occasions and configurations having a second sparsity in time of scheduling occasions, the first sparsity being less than the second sparsity.

40. The method of claim 39, wherein at least some of the configurations having the first sparsity in time have scheduling occasions that coincide with scheduling occasions of at least some of the configurations having the second sparsity in time.

41. The method of claim 34, further comprising:
for each of one or more wireless devices, determining a search space factor, based on sparsity of a search space configuration configured for the respective wireless device and based on a discontinuous receive (DRX) duration configured for the respective wireless device; and
for a given scheduling occasion, prioritizing the wireless devices for scheduling according to the search space factors.

42. The method of claim 41, wherein the search space factor Fss is calculated according to k*periodicity/DRX-duration, where k=0 for a wireless device configured to monitor for scheduling messages in every scheduling opportunity and k>0 otherwise, periodicity is a periodicity of scheduling opportunities for the wireless device, and DRX-duration is a DRX duration configured for the wireless device.

43. The method of claim 34, wherein the method comprises, for each of one or more of the wireless devices, selecting at least one search space configuration to be assigned to the wireless device from available search space configurations, based on one or more of any of:
a maximum acceptable latency for each of one or more services provided to the wireless devices;
a minimum throughput requirement for each of one or more services provided to the wireless device;
an expected loading of one or more scheduling occasions, in view of the selected search space configurations;
power savings needs for the wireless device.

44. The method of claim 43, wherein said selecting at least one search space configuration comprises:
determining that an expected loading of one or more scheduling occasions is greater than a predetermined threshold, for search space configurations having a first time offset of scheduling configurations; and
selecting a search space configuration that has no overlap with another selected search space configuration, in response to said determining.

45. The method of claim 43, wherein said selecting takes into account opportunities for a power saving state for the network node and/or wireless devices between scheduling occasions.

46. The method of claim 34, wherein the method comprises changing a search space configuration for one or more wireless devices, based on one or more of any of:
a change in loading for one or more scheduling occasions; and
a change in a number of UEs served by the network node.

47. The method of claim 34, wherein the method comprises, for at least one wireless device, configuring a first search space configuration having a first sparsity and a second search space configuration having a second sparsity, wherein the first and second search space configurations correspond to first and second bandwidth part identities, (BWP IDs) configured for the at least one wireless device.

48. A network node, comprising:
communication interface circuitry configured to communicate with one or more wireless devices;
processing circuitry operatively coupled to the communication interface circuitry; and
memory operatively coupled to the processing circuitry;
wherein the processing circuitry and memory are configured to use the communication interface circuitry to:
configure each of a plurality of wireless devices with two or more respective search space configurations for monitoring for scheduling messages, the two or more respective search space configurations for each wireless device differing with respect to at least one of (a) sparsity in time of scheduling occasions, (b) time offset of scheduling occasions, and (c) duration of scheduling occasions; and
wherein the processing circuitry and memory are further configured to, for each of one or more of the wireless devices, use the communication interface circuitry to activate one of the configured two or more search space configurations for the respective wireless device, based on a latency requirement and/or a throughput requirement for the respective wireless device.

49. The network node of claim 48, wherein the processing circuitry and memory are configured to activate one of the configured two or more search space configurations for the respective wireless device by:
activating a first search space configuration, which has a first sparsity in time of scheduling occasions, when a data exchange from or to the wireless device is higher than a threshold or a higher control channel capacity is needed than what is available when a second search space configuration is active; and
activating a second search space configuration, which has a second sparsity in time of scheduling occasions, when a data exchange from or to the wireless device is less than the threshold; and
wherein the first sparsity is less than the second sparsity.

50. The network node of claim 48, wherein the processing circuitry and memory are configured to, for each of a first group of the wireless devices, use the communication interface circuitry to activate a respective configured search space configuration having a first time offset of scheduling occasions and, responsive to a load in the scheduling node exceeding a predetermined threshold, activate a respective configured search space configuration having a second time offset of scheduling occasions for each of a second group of wireless devices.

51. The network node of claim 50, wherein the load is a control channel load or a load for a specific scheduling occasion.

52. The network node of claim 50, wherein the processing circuitry and memory are configured to select the first time offset and second time offset to correspond to adjacent slots, so as to maximize a gap between scheduling occasions.

53. The network node of claim 48, wherein the processing circuitry and memory are configured to assign the search space configurations to the plurality of wireless devices so as to include configurations having a first sparsity in time of scheduling occasions and configurations having a second sparsity in time of scheduling occasions, the first sparsity being less than the second sparsity.

54. The network node of claim 53, wherein at least some of the configurations having the first sparsity in time have scheduling occasions that coincide with scheduling occasions of at least some of the configurations having the second sparsity in time.

55. The network node of claim 48, wherein the processing circuitry and memory are configured to:
for each of one or more wireless devices, determine a search space factor, based on sparsity of a search space configuration configured for the respective wireless device and based on a discontinuous receive (DRX) duration configured for the respective wireless device; and
for a given scheduling occasion, prioritize the wireless devices for scheduling according to the search space factors.

56. The network node of claim 48, wherein the processing circuitry and memory are configured to, for each of one or more of the wireless devices, select at least one search space configuration to be assigned to the wireless device from available search space configurations, based on one or more of any of:
a maximum acceptable latency for each of one or more services provided to the wireless devices;
a minimum throughput requirement for each of one or more services provided to the wireless device;
an expected loading of one or more scheduling occasions, in view of the selected search space configurations;
power savings needs for the wireless device.

57. The network node of claim 56, wherein the processing circuitry and memory are configured to select the at least one search space configuration by:
determining that an expected loading of one or more scheduling occasions is greater than a predetermined threshold, for search space configurations having a first time offset of scheduling configurations; and
selecting a search space configuration that has no overlap with another selected search space configuration, in response to said determining.

58. The network node of claim 48, wherein the processing circuitry and memory are configured to change a search space configuration for one or more wireless devices, based on one or more of any of:
a change in loading for one or more scheduling occasions; and
a change in a number of UEs served by the network node.

59. The network node of claim 48, wherein the processing circuitry and memory are configured to, for at least one wireless device, use the communication interface circuitry to configure a first search space configuration having a first sparsity and a second search space configuration having a second sparsity, wherein the first and second search space configurations correspond to first and second bandwidth part identities (BWP IDs) configured for the at least one wireless device.
